(19) United States
(12) Patent Application Publication
(10) Pub. No.: US 2016/0130766 A1
(43) Pub. Date: May 12, 2016

(54) PLANAR SUPPORT WITH TWO FACES FOR WRITING OR DRAWING

(71) Applicant: CANSON, Herouville-Saint-Clair (FR)

(72) Inventor: Philippe Noblet-Reverbel, Vienne (FR)

(21) Appl. No.: 14/933,048

(22) Filed: Nov. 5, 2015

(30) Foreign Application Priority Data
Nov. 7, 2014 (FR) 14 60 821

(51) Int. Cl. D21H 27/32; B32B 27/10; B32B 37/08; B42D 5/00; B32B 37/14; B32B 27/20; B42D 1/00

(52) U.S. Cl. CPC D21H 27/32; B32B 27/20; B32B 27/10; B42D 1/008; B42D 5/003; B32B 37/14; B32B 37/08; B32B 2250/03; B32B 2250/40; B32B 2307/41; B32B 2264/108; B32B 2264/102; B32B 2307/73; B32B 2554/00

(57) ABSTRACT

A planar support with two faces on which hand writing and hand drawing may take place includes an assembly of two fibrous layers having the respective faces, and a thermoplastic polymer preparation between the two fibrous layers. The thermoplastic polymer preparation makes the support opaque to direct transmission of light. The thermoplastic polymer preparation is filled with carbon black, chalk, and/or titanium dioxide to scatter and attenuate light in the thermoplastic polymer preparation.

### FIELD OF THE INVENTION

The present invention relates to a planar support with two faces for graphic designs (writing or drawing) by hand, as well as to a cut sheet of the support, optionally in the form of reams, pads, notebooks or exercise books with sheets. The invention also relates to the method for manufacturing the planar support. The planar support of the invention is particularly suitable for graphics with a marker, such as, for example, a graphic illustration (drawing) with a marker, or writing with a marker. The marker may be a (permanent) marker using a solvent or a marker using water.

### BACKGROUND

Hand drawing with a marker by illustrators on drawing boards produce one copy. Such drawing boards may then be kept as unique copies, or they may then be scanned in order to be subject to a number of reproductions.

Conventionally, the planar supports for hand-drawn graphics are paper supports, or based on paper. Paper is a material mostly based on cellulose or synthetic fibers, mixed with various additives giving the possibility of providing certain properties to the material or to reinforce it, according to the final use intended for the product. The proposed products are relatively thin, with basis weights for example of the order of 60 to 260 g/m².

The users appreciate that a planar support of the paper type may be used on both sides. Nevertheless, in the case of a use of such a support for graphics drawn with markers, whether the latter uses a solvent or water, poses the problem of the crossing of the pigments through the sheet, the material of which is porous. Further, even under the assumption that the pigments do not cross, the shadow of the graphic marks on a face may be visible on the other face. This visibility may be made possible by the small thickness of the support, which depending on its basis weight, cannot be totally opaque. Nevertheless, it is noted that the contours of the shadow may appear in an uncertain way.

In order to make a paper-based support opaque with a barrier effect towards solvents (including water), the use of mineral fillers in the paper pulp and the addition of a fluorinated resin in the latter in a necessarily large amount are known, which imposes significant extra cost. The use of the latter is generally reserved for papers specifically dedicated to the packing of fat products for the agri-feed industry.

Moreover, it is possible to insert a layer or an adhesive jet which may be activated between two paper jets, the adhesive stiffening the whole once it is dried. The adhesive is deposited by means of a specific coating tool. It may be based on a solvent, like a polyurethane adhesive. It may also be based on water like a polyvinyl alcohol adhesive or further a starch adhesive. It may contain opacifying fillers for obtaining an opaque assembly. But for optimizing the effect of the mixture of adhesive and fillers in terms of barrier and opacity, a large concentration of fillers is necessary, which induces a very substantial increase in viscosity or else it is necessary to deposit a very substantial amount thereof, and in both cases, the tools for depositing adhesive may prove to be unsuitable for this kind of application.

It is sometimes proposed to form a paper/solvent-proof film assembly, the assembly being formed with an adhesive or with an intermediate extruded polymer connecting both layers. The film is selected for its opacity, and may be a polyethylene terephthalate or polypropylene film containing, for example, chalk for opacification or printed with an opacifying color on one face, or even an aluminum film. But such an assembly cannot be used as a two-face support for graphics, since one of the faces consists of a leak-proof film.

Further from document FR2922228 a sheet is known, which comprises two fiber layers comprising watermarks and between which a diffusing translucent separator layer of extruded polyethylene loaded with pigments is present. The watermarks are only observable from one side because of the lack of direct transmission of light, combined with the diffusion of light in the thickness of the sheet, indispensable so that the watermark of the front sheet is visible whilst the watermark of the rear sheet is hidden by lack of direct transmission of light.

Thus, there is a lack of a two-faced support for graphics which is well opaque, resistant to the crossing of the solvent and of the pigments of a marker, including a permanent marker, and for which the cost remains moderate.

### SUMMARY OF THE INVENTION

In order to solve this problem, a planar support with two faces is proposed for writing or drawing by hand consisting in an assembly of two fibrous thicknesses for attachment of graphic marks on each of said two faces of the support, and of a thermoplastic polymer preparation thickness positioned between said two fibrous thicknesses, the thermoplastic polymer preparation thickness being involved in the opacification of the support in direct transmission light, characterized in that the preparation of a thermoplastic polymer is loaded so that the scattering of light in the thermoplastic polymer preparation thickness is attenuated.

By means of these characteristics, an opacification effect of the planar support is obtained, which may be used for writing or drawing even with dark and penetrating graphic marks. Indeed, the polymer preparation film has an effect of a material barrier, preventing the pigments and the solvent from crossing the support, and further, the light is attenuated by the support both in transmission and in scattering, because of the polymer preparation. The material receiving the graphic marks on both sides consists of a paper surface, the use of which is customary for artists, amateurs and professionals of graphics.

Advantageously, the thermoplastic polymer preparation comprises at least one colored filler or one opacifying pigment, for example, chalk, titanium dioxide or carbon black. These various components, at a suitable concentration, give the possibility of obtaining attenuation of the scattering of the light by the support while preserving the whiteness of the support.

In particular, the thermoplastic polymer preparation comprises carbon black.

Advantageously, the thermoplastic polymer preparation further comprises chalk or titanium dioxide, in addition to the carbon black, which gives the possibility of not putting too much carbon black while obtaining the scattering effect and of preserving the whiteness of the paper.

Advantageously, the carbon black concentration is comprised between 0.1 and 1%.

In various embodiments, at least one of the two fibrous thicknesses for attaching graphic marks is based on cellulose fibers, synthetic fibers or a mixture of both.

Advantageously, at least one of the two fibrous thicknesses for attaching graphic marks is a fibrous base treated with a hydrophobic material like an alkylketene dimer or AKD, dosed at 0.14% (by weight), pure, with respect to the fibrous bulk. Thus, the pigments of a marker with solvent are well retained at the surface without any smudge.

Advantageously, at least one of the two fibrous thicknesses for attaching graphic marks comprises mechanically or chemically treated fibers so that the surface cohesion is adapted to the marker.

The support, seen as a section, may have a symmetrical structure with respect to a plane of symmetry, both fibrous thicknesses being selected to be identical.

Advantageously, at least one of the two fibrous thicknesses for attaching graphic marks is a whitened fiber material or stemming from recycled paper.

Advantageously, the basis weight of the assembly is comprised between 60 and 260 g/m², and for example between 120 and 200 g/m².

Advantageously, the polymer preparation thickness has a surface mass between 5 and 80 g/m², for example between 10 and 40 g/m².

Advantageously, the thermoplastic polymer preparation (1150) comprises at least one polyolefin, for example polyethylene, or a bioplastic.

A sheet cut to a format for manual graphic illustration is also proposed, in a planar support as mentioned above, as well as a ream, a spiral paper block, a pasted block, a notebook, a book or an exercise book with such sheets.

A method for manufacturing a planar support is also proposed, comprising the assembling of two fibrous thicknesses for attachment of graphic marks and of a thickness of a thermoplastic polymer preparation positioned between said two thicknesses for attaching graphic marks, characterized in that the composition of the thermoplastic polymer preparation is adapted so that light scattering in said thermoplastic polymer preparation thickness is attenuated.

The method may comprise other features among which:
it is proceeded with the extrusion of the thermoplastic polymer preparation as a casting between two fibrous layers, and then with the cooling of the polymer preparation so that both fibrous layers are set together.
the assembling comprises the lamination of two fibrous layers, with the thermoplastic polymer preparation thickness taken between both fibrous layers.
a single jet of fibrous material is used for forming one of the thicknesses for attaching graphic marks.
at least one of the thicknesses for attaching graph marks is, for assembling, obtained by unwinding a paper spool.

The invention will now be described in connection with the appended Figures.

### BRIEF DESCRIPTION OF DRAWING FIGURES

FIG. 1 is a diagram of an embodiment of the manufacturing method according to the invention.

FIG. 2 is a view of a planar support for graphics according to the invention, in a sectional view.

FIG. 3 is a view of a method of use of the support according to the invention.

FIG. 4 deals with a presentation of the product, in one embodiment.

### DETAILED DESCRIPTION

With reference to FIG. 1, which is a sectional view, an extruder machine 100 is used for depositing, through a die, a molten polymer 110, as a casting, between two layers 120 and 121 of fibrous material which for example are unwound from two material unwinders 130 and 131 bearing paper spools.

The assembly consisting of the three layers is applied between two rollers 140 and 145, by means of a uniformly applied pressure. Lamination of the three layers is thus achieved.

The assembly of the three layers, once assembled in this way, is then driven onto the surface of one of the rollers, here roller 145 which has a sufficient diameter so that the time spent on the roller allows the material to cool off, so that the three layers are set together.

The assembly then optionally passes over an intermediate roller 150, before being wound on a winder in order to form a product coil 160.

Other equivalent assemblies are of course possible.

The flow rate of the extruder machine 100 and the speed of the unwinders 130 and 131 give the possibility of adjusting the amounts of material used.

In an exemplary embodiment, two identical single jet papers of 90 g/m² are provided on the unwinders 130 and 131. The spool of the unwinder 130 and the spool of the unwinder 131 may also be multi-jet paper spools, for example with two jets.

For the molten polymer 110, molten low density polyethylene obtained by extrusion at 300° C., deposited in an amount of 20 g/m² is used. The raw material consists of 85% by weight of non-filled polyethylene granules, 1% by weight of a polyethylene composition comprising carbon black and 14% by weight of a polyethylene composition comprising titanium dioxide of the rutile kind.

The polyethylene preparation obtained by mixing and melting and depositing between both paper jets, comprises finally titanium dioxide TiO₂ at a concentration comprised between 1.7 and 2.2 g/m², i.e. 10% by weight, and more generally between 9 and 15% or between 8 and 20%.

Further, the carbon black concentration in this final preparation is from 0.03 to 0.05 g/m², i.e. 0.2% by weight, and more generally between 0.15 and 0.5%, or between 0.1 and 1%.

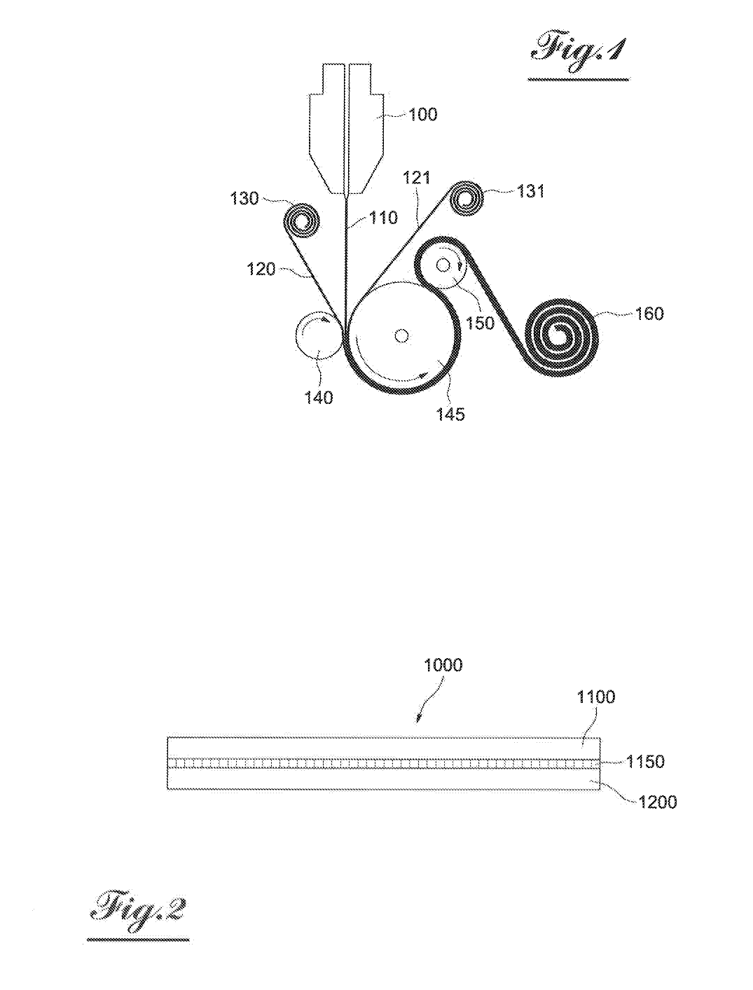

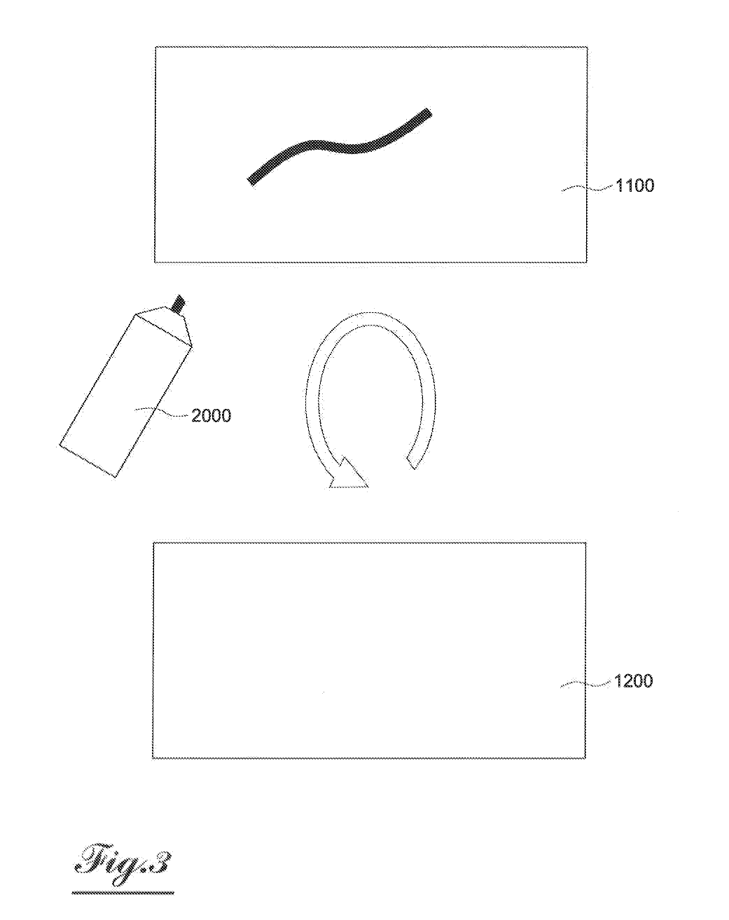

An embodiment of the planar support 1000 according to the invention is illustrated in FIG. 2, as a sectional view. Finally, it consists of two layers 1100 and 1200 of a fibrous material allowing attachment of graphic marks, connected through a polymer film 1150.

The fibrous material layers may be layers of paper treated with a hydrophobic material, for receiving the pigments of a marker with a solvent.

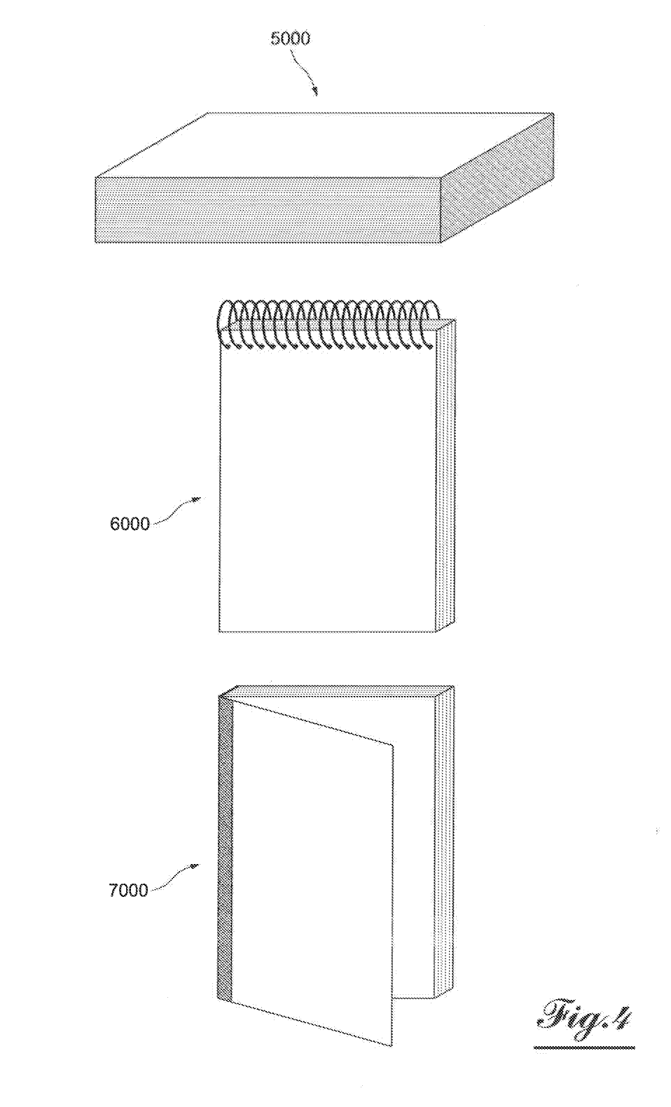

The use of the support is illustrated in FIG. 3. It may be used for graphics on its first face 1100, by means of a marker 2000, which may be a marker using water or using a solvent. It is also possible to use paint, Chinese ink, pen, pencil, drawing charcoal or pastel. The graphic marks are attached by the fibrous material, in a solid and persistent way. By turning over the sheet, the graphic marks borne by the face 1100 remain invisible on the face 1200. Indeed, the scattered light in the polymer layer is attenuated because of the presence of fillers in the latter, so that the shadows of the graphic marks do not appear on the face 1200.

A ream 5000 of paper comprising stacked sheets separated from each other is illustrated in FIG. 4. Each sheet consists of a planar support 1000 as illustrated in FIG. 2.

A notebook 6000 of sheets bound by a spiral of the notebook forming a binding is also illustrated, the sheets being individually detachable from the binding. At the place of the spiral, straight spiral turns parallel with each other may be used.

A book with a hard cover or <<hard book>> is also illustrated, here a book with a rolled-edge cover and sewn sheets 7000, the pages of which consist of the planar support according to the invention.

The invention is not limited to the embodiment shown but extends to all the alternatives within the range of the scope of the claims.

1. A planar support with two faces on which hand writing and hand drawing may take place, the planar support including
an assembly of two fibrous layers having the respective faces, and
a thermoplastic polymer preparation positioned between the two fibrous layers, wherein
the assembly is produced by cooling of the polymer preparation from a molten state,
the thermoplastic polymer preparation provides opacity of the support and is filled with carbon black and one of chalk and titanium dioxide so that light scattered in the thermoplastic polymer preparation is attenuated while the support retains whiteness of the fibrous layers.

2. The planar support according to claim 1, wherein the carbon black is present in a concentration in a range from 0.1% to l%, by weight of the thermoplastic polymer preparation.

3. The planar support according to claim 1, wherein at least one of the fibrous layers is based on one of cellulose fibers, synthetic fibers, and a mixture of cellulose and synthetic fibers.

4. The planar support according to claim 1, wherein at least one of the fibrous layers has been treated with a hydrophobic material.

5. The planar support according to claim 1, wherein at least one of the fibrous layers comprises mechanically or chemically treated fibers.

6. The planar support according to claim 1, having, in a sectional view, a symmetrical structure.

7. The planar support according to claim 1, wherein at least one of the fibrous layers is one of a whitened fibrous material and recycled paper.

8. The planar support according to claim 1, having a basis weight ranging from 60 g/m² to 260 g/m².

9. The planar support according to claim 1, wherein the polymer preparation has a density between 5 g/m² and 80 g/m².

10. The planar support according to claim 1, wherein the thermoplastic polymer preparation comprises at least one of a polyolefin and a bioplastic.

11. A sheet cut to a format for manual graphic illustration, in a support according to claim 1.

12. A ream, a spiral pad, a pasted pad, a notebook, a book, or an exercise book of sheets, according to claim 11.

13. A method for manufacturing a planar support, comprising:
assembling two fibrous layers for drawing or writing, and
positioning a thickness of a thermoplastic polymer preparation between the two fibrous layers, wherein the thermoplastic polymer preparation scatters and attenuates incident light.

14. The manufacturing method according to claim 13, comprising extruding the thermoplastic polymer preparation in a molten state between the two fibrous layers, and then cooling the polymer preparation so that the fibrous layers are set.

15. The manufacturing method according to claim 13, wherein the assembling comprises lamination of the two fibrous layers, with the thermoplastic polymer preparation located between the two fibrous layers.

16. The manufacturing method according to claim 13 comprising forming a single jet of a fibrous material to form one of the fibrous layers.

17. The manufacturing method according to claim 13, wherein at least one of the fibrous layers is supplied in the assembling, by unwinding a paper spool.
